(19) United States
(12) Patent Application Publication
(10) Pub. No.: US 2014/0173458 A1
(43) Pub. Date: Jun. 19, 2014

(54) SYSTEM AND METHOD FOR SHARING EVENT INFORMATION USING ICONS

(71) Applicant: SONY CORPORATION, Tokyo (JP)

(72) Inventors: Jonathan Paul Gaiser, San Diego, CA (US); Libiao Jiang, San Diego, CA (US); Benjamin Wai-Ming Lo, San Diego, CA (US); Tonni Larsen, Escondido, CA (US); Bryan Mihalov, Escondido, CA (US); Hye Hoon Yi, Escondido, CA (US)

(73) Assignee: SONY CORPORATION, Tokyo (JP)

(21) Appl. No.: 13/717,971

(22) Filed: Dec. 18, 2012

(51) Int. Cl. G06F 3/0481

(52) U.S. Cl. CPC G06F 3/04817
USPC 715/752

(57) ABSTRACT

An apparatus includes at least one processor, at least one display controlled by the processor, and at least one wireless transceiver communicating with the processor. The processor is configured to send, to at least one recipient, a message including data representing at least one non-alphanumeric who icon representing a person. The message also includes data representing at least one non-alphanumeric what icon representing an event and/or activity, as well as at least one non-alphanumeric when icon representing a time associated with the event and/or activity.

### I. FIELD OF THE INVENTION

The present application is directed to sharing events and activities in a social networking context using consumer electronics devices such as smartphones and tablet computers.

### II. BACKGROUND OF THE INVENTION

The increasing prevalence of mobile, hand-held, and touch screen consumer electronics (CE) devices presents the increased the ability of CE device users to communicate with each other. However, many of these CE devices do not have an adequate input area on which to comfortably and accurately type messages. For example, a touch-screen “smart” watch may not have a keyboard of any kind. Even if it were to have one, typing on a CE device of that size would prove difficult and frustrating. Present principles recognize the foregoing observations and provide improved methods and devices for CE device users to communicate with each other.

### SUMMARY OF THE INVENTION

Accordingly, as recognized herein icons related to various activities a user is or will be participating in, as well as various locations a user is or will be going, can be transmitted to the user's contacts to convey information without utilizing, e.g., a conventional keyboard. The CE devices discussed herein are typically, by not necessarily, portable and may be implemented, without limitation, by (and communicate with) smart phones, music players, smart watches, tablet computers, personal digital assistants (PDAs), laptop computers, e-readers such as electronic books, a vehicle's electronic system and/or display, televisions including Internet-enabled and smart TVs, and still other CE devices.

Thus, in one embodiment an apparatus includes at least one processor, at least one display controlled by the processor, and at least one wireless transceiver communicating with the processor. The processor is configured to send, to at least one recipient, a message including data representing at least one non-alphanumeric who icon representing a person. The message also includes data representing at least one non-alphanumeric what icon representing an event and/or activity, as well as at least one non-alphanumeric when icon representing a time associated with the event and/or activity. If desired, the processor may be configured to send the message to plural recipients.

In some embodiments, the message may include data representing an alpha-numeric descriptor of at least one icon for overlay of the descriptor on the at least one icon at a recipient device, while in other embodiments the message may not include data representing any alpha-numeric descriptor of the icons.

Additionally, if desired the processor may be configured to automatically add the event and/or activity to a calendar to reflect that the person is participating in the event and/or activity represented by the what icon at the time represented by the when icon. Also if desired, the processor may be configured to cause an event page reflecting information about the event and/or activity to be created on a social networking service.

Also, in some embodiments the message may include a selectable invitation for the recipient to join the activity, where the message is configured to cause the recipient to send an accept message back to the apparatus when the invitation is selected. Furthermore, in some embodiments the apparatus can be a telephone and the message can include a call selector element configured to cause, when selected the recipient, the recipient to call the apparatus.

Voice commands may also be used in accordance with present principles. Accordingly, at least one of the icons may be created in response receiving at least one voice command to create the icon. Further, at least one of the icons created in response to the voice command can reflect additional information provided in the voice command.

In another embodiment, an apparatus includes at least one processor, at least one display controlled by the processor, and at least one wireless transceiver communicating with the processor. The apparatus is configured to receive, from at least one sender, a first message including data representing at least one non-alphanumeric who icon representing a person, at least one non-alphanumeric what icon representing an event, and at least one non-alphanumeric when icon representing a time associated with the event. Furthermore, the processor is configured to cause the icons to be presented on the display along with a me too icon selectable to cause the processor to return a second message to the sender indicating a desire to join the event.

In yet another embodiment, a method includes presenting at least one selectable element on a sender consumer electronics (CE) device. The method also includes, responsive to user selection of the at least one element, creating a first message including data representing at least one non-alphanumeric what icon, the what icon representing an item, a location, an event, and/or activity. The method then includes transmitting the first message to at least one recipient CE device for presentation on the recipient CE device. The message includes a selector configured to cause, when selected by the recipient at the recipient CE device, a second message to be automatically sent from the recipient CE device to the sender CE device indicating the user of the recipient CE device also wants the item, intends to meet at the location, and/or intends participate in the event and/or activity.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system for exchanging Me Too messages and information;

FIG. 2 is a flow chart of example logic for sending a “Me Too” message from a sending CE device;

FIG. 3 is a flow chart of example logic for receiving a “Me Too” message at a receiving CE device;

FIG. 4 is a flow chart of example logic for sending a “Me Too” message responsive to selection of a “Me Too” icon on a webpage;

FIG. 5 is a flow chart of example logic for receiving a “Me Too” message at a receiving CE device once sent in response to selection of a Me Too icon on a webpage;

FIG. 6 depicts an exemplary Me Too icon;

FIG. 7 is an exemplary diagram for creating/selecting a who icon;

FIG. 8 is an exemplary diagram for creating/selecting what and when icons;

FIG. 9 is an exemplary diagram illustrating a Me Too activity icon being sent to another CE device;

FIG. 10 shows exemplary icons to be used in accordance with present principles;

FIG. 11 is a diagram of plural CE devices receiving an activity icon;

FIGS. 12 and 13 are illustrations of exemplary activity icons indicating the number of users participating in an activity;

FIG. 14 show additional exemplary who icons;

FIG. 15 show additional exemplary what icons;

FIG. 16 show additional exemplary when icons;

FIGS. 17-19 are exemplary diagrams illustrating how Me Too messages facilitate communication between two CE device users;

FIG. 20 is an illustration of an exemplary Me Too activity icon presented on a tablet computer;

FIGS. 21 and 22 are exemplary webpages of an E-store with a Me Too icon on the webpage; and

FIGS. 23 and 24 show additional exemplary Me Too activity icons.

### DETAILED DESCRIPTION OF THE PREFERRED EMBODIMENT

It is to be understood that the figures below generally show methods steps in conjunction with the devices disclosed herein.

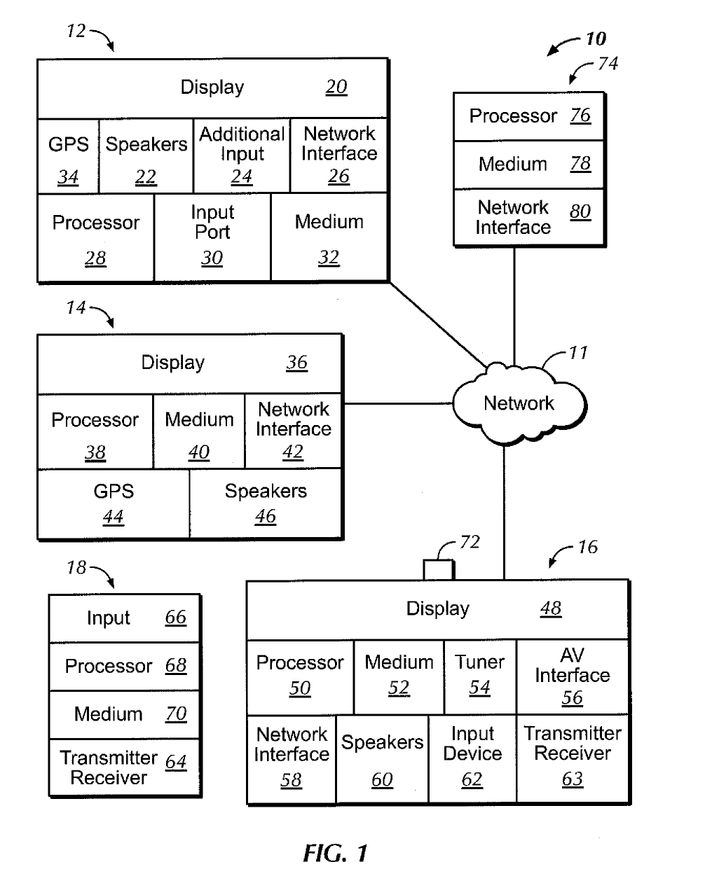

Beginning in reference to FIG. 1, an exemplary system 10 is shown. The system 10 includes a tablet computer 12, smart watch 14, and television 16 associated with a remote control (RC) 18. First describing the tablet computer 12, it includes a touch enabled display 20, one or more speakers 22 for outputting audio such as audible alerts, and an additional input device 24 such as, e.g., a track pad or an audio receiver/microphone for receiving voice commands and input. The tablet computer 12 also includes a network interface 26 for communication over at least one network 11 such as the Internet, an WAN, an LAN, etc. under control of a processor 28, it being understood that the processor 28 controls the tablet computer 12. The network interface 26 may be, e.g., a wired or wireless modem or router, or other appropriate interface such as, e.g., a wireless telephony transceiver. In addition, the tablet computer 12 includes an input port 30 such as, e.g., a USB port, and a tangible computer readable storage medium 32 such as disk-based or solid state storage. Moreover, a GPS receiver 34 is included on the tablet computer 12 and is configured to receive geographic position information from at least one satellite and provide the information to the processor 28, though it is to be understood that another suitable position receiver other than a GPS receiver may be used in accordance with present principles.

Also shown in FIG. 1 is a smart watch 14. The watch 14 includes a touch enabled display 36, a processor 38 controlling the watch 14, a tangible computer readable storage medium 40 such as disk-based or solid state storage, and a network interface 42 such as, e.g., a wired or wireless modem or router, or other appropriate interface such as, e.g., a wireless telephony transceiver, it being understood that the network interface 42 communicates over the network 11. Note that additional input devices may also be included on the smart watch 14, such as, e.g., an audio receiver/microphone for receiving voice commands and input. The smart watch 14 also includes a GPS receiver 44 configured to receive geographic position information from at least one satellite and provide the information to the processor 38, though it is to be understood that another suitable position receiver other than a GPS receiver may be used in accordance with present principles. Also note that at least one speaker 46 is shown for outputting audio such as audible alerts.

As previously indicated, the system 10 may also include a television (TV) 16. The TV 16 may be Internet-enabled, a smart TV, and/or a touch enabled TV. Accordingly, the TV 16 includes a touch enabled display 48. The TV 16 also includes a processor 50 controlling the TV 16, a tangible computer readable storage medium 52 such as disk-based or solid state storage, and a TV tuner 54. Additionally, the TV 16 includes an audio/video interface 56 to communicate with other devices electrically/communicatively connected to the TV 16 such as, e.g., a set-top box, a DVD player, or a video game console over, e.g., an HDMI connection. The TV also includes a network interface 58 such as, e.g., a wired or wireless modem or router, or other appropriate interface such as, e.g., a wireless telephony transceiver, it being understood that the network interface 58 communicates over the network 11. Furthermore, the TV 16 includes at least one speaker 60 and an input device 62 such as, e.g., a keypad and/or audio receiver/microphone for receiving voice commands and input. Note that a camera 72 is also shown and may be, e.g., a thermal imaging camera, a digital camera such as a webcam, and/or camera integrated into a TV 16 and controllable by the processor 50 to gather pictures/images and video of viewers/users of the TV 16. Though not shown, in certain embodiments the TV 16 may also include a GPS receiver in accordance with present principles.

The TV 16 also has a transmitter/receiver 63 for communicating with a TV remote control 18 associated with the TV 16 to thus input commands using the RC 18 to control the TV 16. Accordingly, the RC 18 also has a transmitter/receiver 64 for communicating with the TV 16 through the transmitter/receiver 63. The RC 18 also includes an input device 66 such as a keypad or touch screen display, as well as a processor 68 for controlling the RC 18 and a tangible computer readable storage medium 70 such as disk-based or solid state storage.

Still in reference to FIG. 1, a server 74 is also shown. The server 74 includes at least one processor 76, at least one tangible computer readable storage medium 78 such as disk-based or solid state storage, and at least one network interface 80 that, under control of the processor 76, allows for communication with the devices 12, 14, and 16 over the network 11. Note that the network interface 80 may be, e.g., a wired or wireless modem or router, or other appropriate interface such as, e.g., a wireless telephony transceiver. Accordingly, in some embodiments the server 74 may be an Internet server and may include and perform “cloud” functions such that the devices 12, 14, and 16 access a “cloud” environment via the server 74.

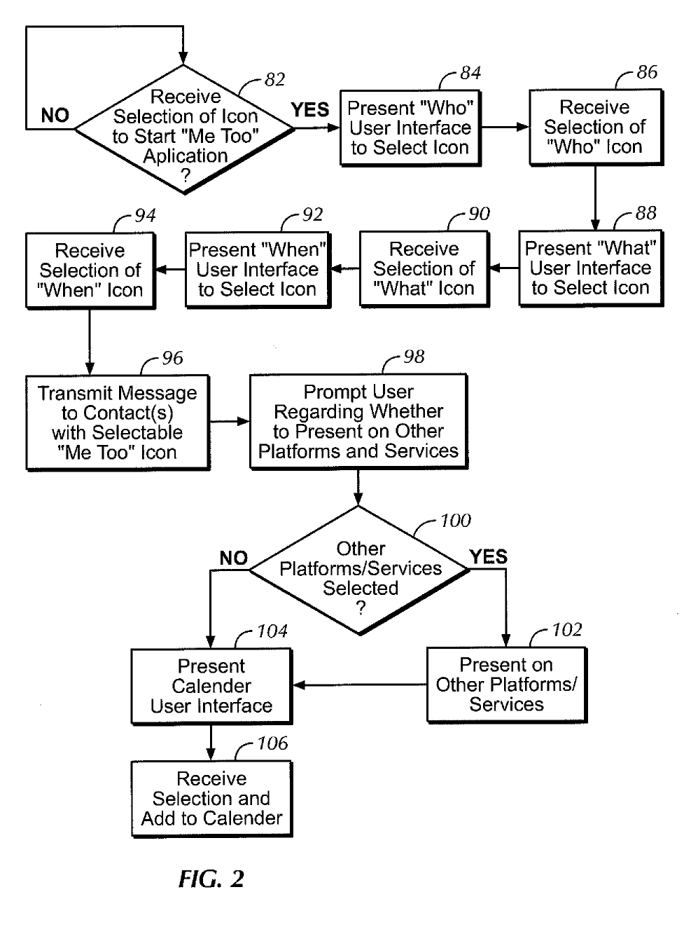

Before describing FIG. 2, note that present principles recognize that the devices 12, 14, 16, and 74, and any other devices used in accordance with present principles, may include some or all of the components described in reference to any of the other devices to undertake present principles. Even further, it is to be understood that that the respective processors described above are capable of executing all or part of the logic discussed below to undertake present principles. Moreover, note that software code implementing present logic executable by the respective processors may be stored on the respective mediums of each device to undertake present principles. For completeness, also note that the respective displays and speakers of the devices shown in FIG. 1 are able to present information in accordance with present principles under control of their respective processors.

Last, note that other CE devices other than the ones shown in FIG. 1 may be used in accordance with present principles, such as, e.g., smart phones, music players, personal digital assistants (PDAs), laptop and desktop computers, c-readers such as electronic books, and a vehicle's electronic system and/or display.

Now in reference to FIG. 2, a flow chart of example logic for sending a “Me Too” message from a sending CE device using, e.g., a “Me Too” application or service in accordance with present principles is shown, it being understood that present principles may be implemented by state logic as well as deterministic logic flows. Beginning at decision diamond 82, the logic determines whether it has received a user's selection of a “Me Too” icon, and/or input to launch a “Me Too” application and/or process. If the logic determines no such thing has been received, the logic may loop back around and continue making the determination at diamond 82 until such time as an affirmative determination is made.

After making an affirmative determination at diamond 82, the logic proceeds to block 84 where the logic presents a “who” user interface (UI) from which a user may select an icon representing, e.g., himself or herself (such as a photograph). Thus, in some embodiments the icon selected at block 84 may include a picture of the user. After receiving the “who” icon selection at block 86, the logic then moves to block 88 where the logic presents a “what” user interface (UI) from which a user may select an event, activity, etc., in which the user wishes to participate. The “what” selection is then received at block 90.

Thereafter, the logic proceeds to block 92 where the logic presents a “when” UI from which a user may select, e.g., a general and/or approximate time of day for when the user intends to participate in the event or activity. For instance, one option that may be presented on the “when” UI may be a selectable “this afternoon” element, indicating that the user wishes to participate in the event or activity later that day. The logic then receives the “when” selection at block 94 and proceeds to block 96. At block 96 the logic processes the user selections, creates a message including the icons and/or information input by the user, and transmits the message to one or more of the user's contacts. The contacts that receive the message may have been, e.g., previously designated by the user. For instance, the user may have previously designated friends in the “Me Too” application that are to receive “Me Too” messages, or the user may have previously linked a contact list to the “Me Too” application from which friends to receive the message may be selected. Still further, the user may select particular contacts after the message is created but before it is sent.

Regardless, it is to be understood that the message that is transmitted includes a selectable “Me Too” icon and/or invitation that may be selected by a recipient of the message to indicate that the recipient intends to participate or join with the user in the event or activity. Accordingly, the message may be configured to cause the recipient to send an accept message back to the apparatus when the “Me Too” icon and/or invitation is selected at the recipient device.

Still in reference to FIG. 2, the logic moves from block 96 to block 98 where the logic prompts the user to select whether to present the “Me Too” icons and/or information described above to other people through, e.g., another application, service, or platform such as a social networking service. At block 98 the logic may even present a list of other platforms or services that are selectable by a user to present the “Me Too” icons/information thereon, such as a Twitter selector and a Facebook selector. Then at decision diamond 100 the logic determines whether an affirmative or negative response to the prompt presented at block 98 has been received. If the logic determines that an affirmative response has been received, the logic proceeds to block 102 where the logic publishes, presents, transmits, creates an events page regarding, etc., the “Me Too” icons/information to/on the selected applications, services, and/or platforms. The logic then proceeds to block 104. However, if a negative response was determined to have been received at diamond 100, the logic skips block 102 and moves directly to block 104.

At block 104 the logic prompts the user to select whether to add the event to a calendar associated with the user such as, e.g., a Google calendar. Assuming the user responds to the prompt by indicating that he or she wishes the event be added to their calendar, the logic then moves to block 106 where it receives the response and automatically adds the event and any associated information to the calendar(s). Otherwise, the logic may end.

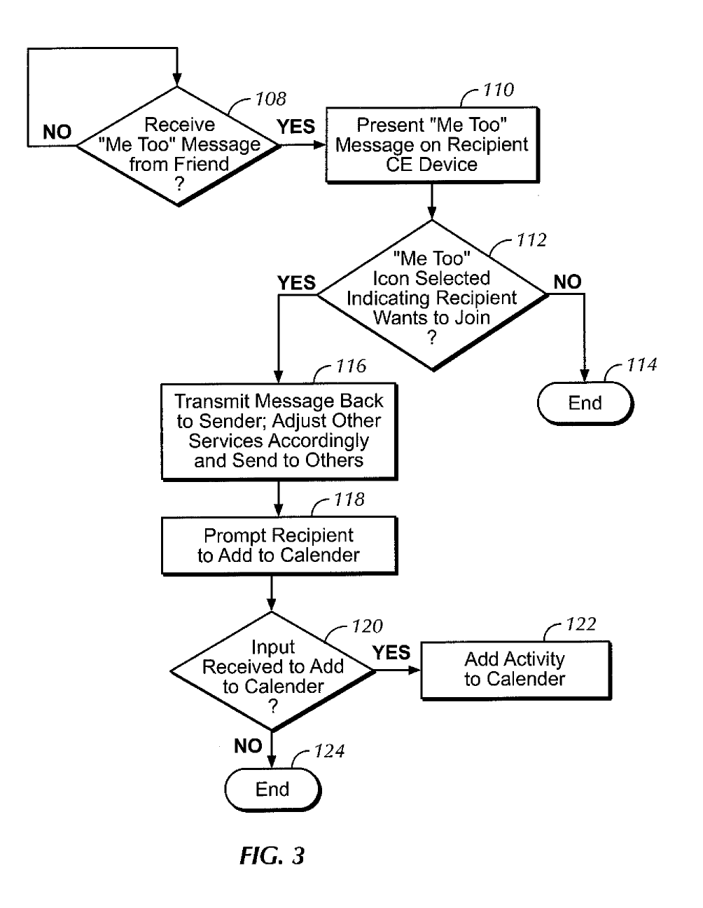

Before describing FIG. 3, it is to be understood that in varying embodiments the message may or may not include data representing an alpha-numeric descriptor of at least one of the selected icons for overlay of the descriptor on the one icon. Moreover, voice commands may be used in accordance with present principles to input any of the selections described herein, e.g., when prompted by the prompts described herein, and that voice commands may be used to input and/or specify additional information as well.

Now in reference to FIG. 3, a flow chart of example logic for receiving a “Me Too” message at a receiving CE device in accordance with present principles is shown. Beginning at block 108, the logic determines whether it has received a “Me Too” message from, e.g., a friend or family member over a “Me Too” service indicating that the friend is participating in an activity at a certain time. If the logic determines no such message has been received, the logic may loop back around and continue making the determination at diamond 108 until such time as an affirmative determination is made.

After making an affirmative determination at diamond 108, the logic proceeds to block 110 where the logic presents the “Me Too” message on the user's CE device. The logic then proceeds to decision diamond 112 where the logic determines whether a “Me Too” icon/invitation included with the message has been selected by the user. If the logic determines that the “Me Too” icon/invitation has not been selected, the logic may move to block 114 where the logic ends. However, if the logic determines that the “Me Too” icon/invitation has been selected, the logic instead moves to block 116 where the logic transmits/returns a response message to the sender indicating the user's desire to join the activity specified in the “Me Too” message sent by the sender.

If desired, the response message may also be sent to other contacts, e.g., also using the “Me Too” application. The other people may be selected, e.g., from a contact list or input by the user. Also if desired, the user may be prompted with and select an emoticon to be included in the response message.

Still in reference to FIG. 3, after block 116 the logic moves to block 118 where a prompt is presented on the CE device asking the user whether the activity should be added to a calendar associated with the user, such as, e.g., a Google calendar. The logic then moves to decision diamond 120 where the logic determines whether input has been received from the user indicating that the user would like to add the activity to the user's calendar(s). If the user responds to the prompt by indicating that he or she wishes the activity be added to their calendar(s), the logic then moves to block 122 where it receives the response and automatically adds the event to the calendar(s). If no response has been received, or if the user provides input indicating the user does not wish to add the activity and any associated information to one or more of the user's calendars, the logic instead moves to block 124 where it ends. Note that in exemplary embodiments, the calendars described above in reference to FIGS. 2 and 3 (or any other calendar used in accordance with present principles) may be, e.g., group or community calendars viewable by members of the group or community (e.g., a Yahoo Group).

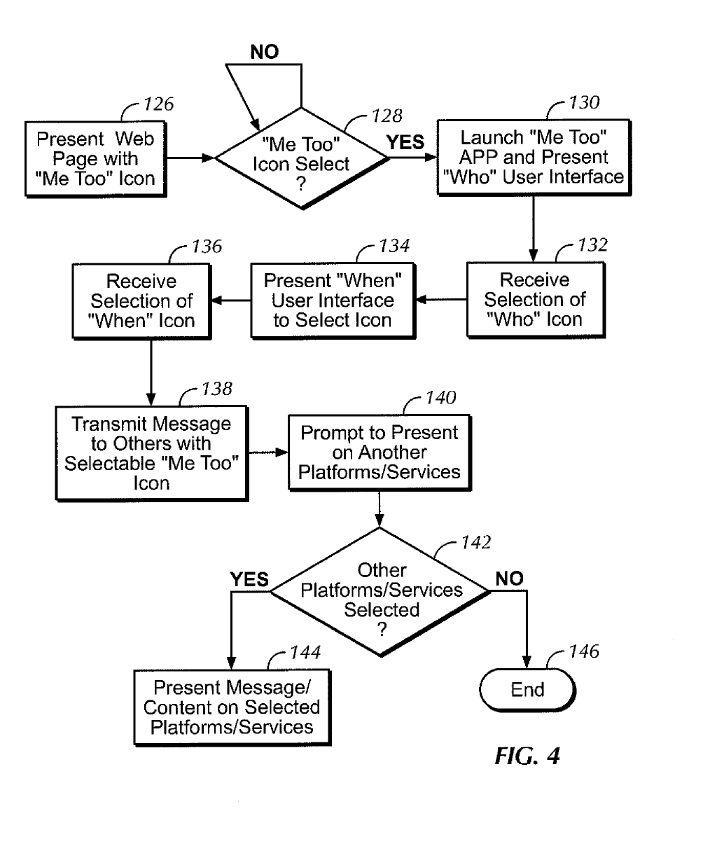

Turning to FIG. 4, a flow chart of example logic for sending a “Me Too” message responsive to selection of a “Me Too” icon on a webpage is shown. For example, the logic of FIG. 4 may be executed when a user of a CE device is navigating a shopping website and comes across an item they wish to purchase at a later time. A selectable “Me Too” icon such as those described herein may be overlaid on to a portion of the webpage. Thus, when selected, the “Me Too” icon may initiate the logic presently described.

Accordingly, the logic begins at block 126 where the logic presents a webpage such as, e.g., an Amazon.com page for a particular book. The logic also overlays or otherwise presents a selectable “Me Too” icon on the page at block 126, although it is to be understood that in other embodiments the content provider (e.g., Amazon.com) or another third party may include a “Me Too” icon on the webpage itself (e.g., such that the logic of FIG. 4 need not overlay a “Me Too” icon) and be able to execute a “Me Too” application in accordance with present principles. In other words, third parties such as websites may participate in the actions and undertake all or part of the logic described herein.

Regardless, after block 126 the logic moves to decision diamond 128 where the logic determines whether it has received a selection of the “Me Too” icon. If the logic determines that it has not received such a selection, the logic may loop back to diamond 128 and continue until such time as the “Me Too” icon is selected. Once the “Me Too” icon is selected from, e.g., a webpage, the logic then moves to block 130 where the logic launches a “Me Too” application/process on the CE device viewing the webpage and presents a “who” UI such as those described herein. Then at block 132 the logic receives the user's “who” icon selection and moves to block 134, where the logic presents a “what” UI such as those described herein. The logic then moves to block 136 where the logic receives the user's “what” icon selection.

Thereafter, the logic proceeds to block 138 where the logic processes the user selections, creates a message including the icon selections and/or information input by the user, and transmits the message to one or more of the user's friends in accordance with present principles. Note that the message transmitted at block 138 may include a link to the website on which the selected “Me Too” icon was overlaid so that recipients of the message may view the website by clicking the link. Thus, for instance, if a user wants to purchase a book at a later time, the user may select a “Me Too” icon overlaid on the E-store webpage for the book to cause the user's CE device to transmit a message containing a link to the webpage and an indication that the user wishes to buy the book at a later time, which may then be viewable by the user's contacts.

Still in reference to FIG. 4, the logic proceeds from bock 138 to block 140 where the logic prompts the user to select whether to present the “Me Too” icons and/or information described above to other people through, e.g., another application or service such as a social networking service. At block 140 the logic may even present a list of other services that are selectable by a user to present the “Me Too” icons/information thereon, such as a Twitter selector and a Facebook selector. Then at decision diamond 142 the logic determines whether an affirmative or negative response to the prompt presented at block 140 has been received. If the logic determines that an affirmative response has been received, the logic proceeds to block 144 where the logic posts, publishes, presents, transmits, creates an events page regarding, etc., the “Me Too” icons/information (including, e.g., a link to the webpage, a screen shot of the webpage or item to be purchased, an icon reflecting the item to be purchased, etc.) to/on the selected applications and/or services. However, if a negative response was determined to have been received at diamond 142, the logic instead jumps to block 146 where the logic ends.

Now in reference to FIG. 5, a flow chart of example logic for receiving a “Me Too” message at a receiving CE device once sent as described in reference to FIG. 4 is shown (e.g., the message includes a link to a webpage). Beginning at decision diamond 148, the logic determines whether it has received a “Me Too” message from, e.g., a friend over a “Me Too” platform/service indicating that the friend wishes to purchase an item. If the logic determines no such message has been received, the logic may loop back around and continue making the determination at diamond 148 until such time as an affirmative determination is made.

After making an affirmative determination at diamond 148, the logic proceeds to block 150 where the logic presents the “Me Too” message on the user's CE device. However, it is to be understood that in other embodiments and/or by changing one or more settings of the “Me Too” application executing on the recipient's CE device, the logic may cause the webpage itself rather than the Me Too message to be presented on the CE device.

Regardless, after presenting the Me Too message the logic proceeds to decision diamond 152 where the logic determines whether a “Me Too” icon included with the message has been selected by the user. If the logic determines that the “Me Too” icon has not been selected, the logic may move to block 154 where the logic ends. However, if the logic determines that the “Me Too” icon has been selected at diamond 152, the logic instead moves to block 156 where the logic may transmit/return a response message to the sender indicating the user's desire to, e.g., also purchase the item specified in the message or otherwise participate in the online activity specified in the message.

In the exemplary embodiment currently described, it is to be understood that selection of the Me Too icon may cause other things to occur responsive to its selection. For instance, a recipient may wish to purchase the item from an E-store such as Amazon.com specified in the Me Too message. Thus, selection of the Me Too icon in this context may, e.g., automatically cause an Amazon.com purchase web page to be presented on the recipient's CE device so that the recipient may purchase the item for the sender of the message. Accordingly, the Me Too message sent to the recipient may also include other information about the sender, such as the sender's address, telephone number, etc., to facilitate quick and easy purchasing of the item by the recipient.

As but another example, selection of the Me Too icon by the recipient may automatically cause a Me Too message and/or post to be presented on a Me Too platform/service (or other social networking application) such that it is viewable by more people than the sender and recipient, and indicates that the recipient wishes to buy the item for the sender at a later time, or otherwise approves of the sender's desire to purchase the item.

Accordingly, if desired, at block 156 the message sent from the recipient's CE device may also be sent to other people, e.g., using the “Me Too” application in accordance with present principles. Also if desired, the user may be prompted with and select an emoticon to be included in the response message.

As an aside, note that Me Too icons and the principles described herein may also be use in the video gaming context and presented on video game screens similar to how the present application describes presenting Me Too information on social networking sites such as Facebook and Twitter.

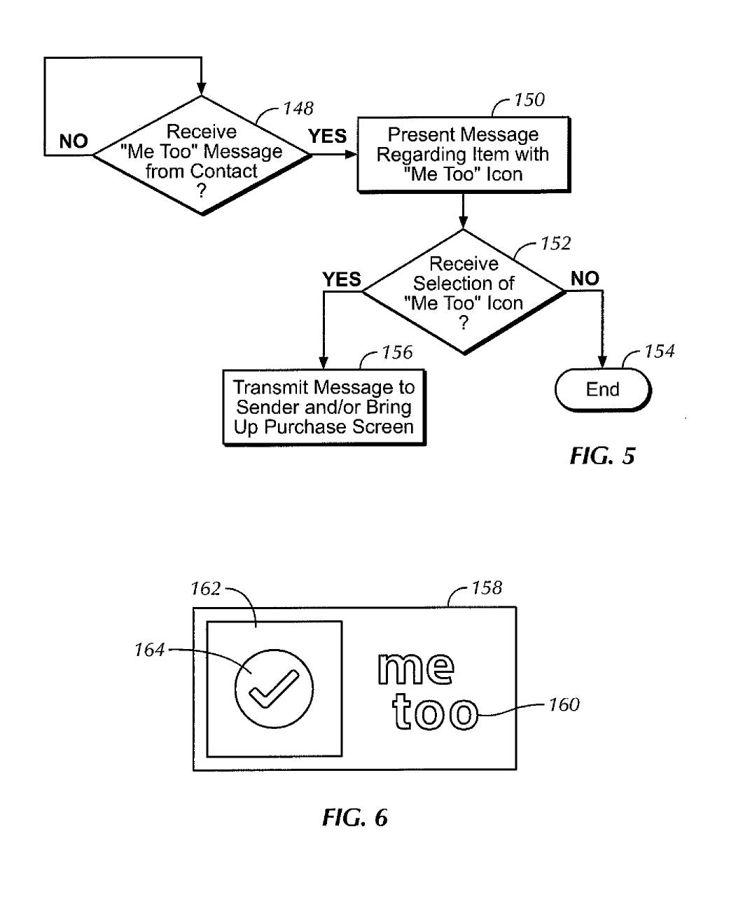

Now in reference to FIG. 6, an exemplary Me Too icon 158 that may be used in accordance with present principles is shown. The icon 158 is a copyright of Sony Corporation 2012 by virtue of this declaration. The Me Too icon 158 optionally includes text 160. The icon 158 also includes a check box 162 that is selectable to provide input to a CE device processor indicating that the Me Too icon has been selected in accordance with present principles. Accordingly, when selected, a check mark 164 may appear in the box 162.

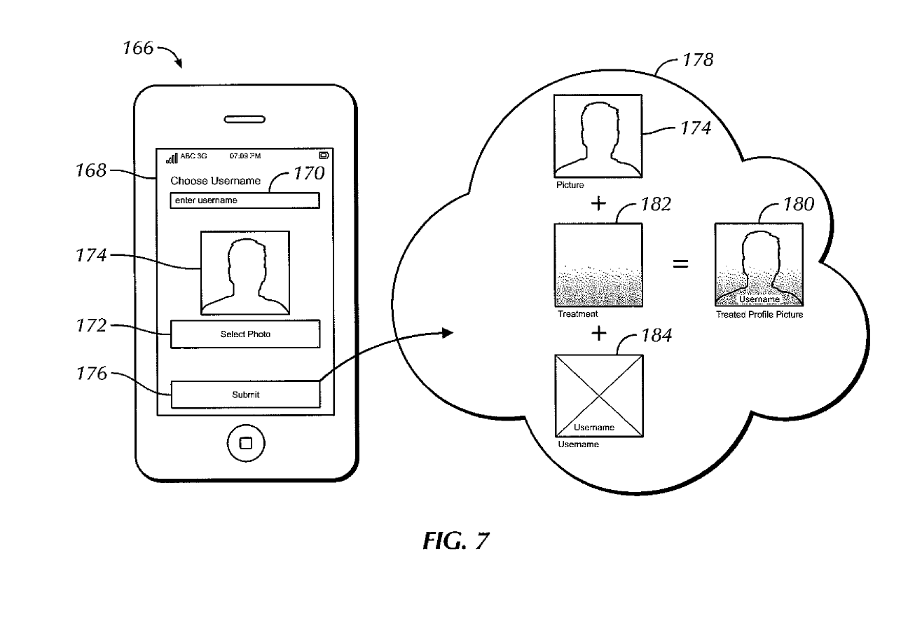

Now in reference to FIG. 7, an exemplary diagram for creating a who icon to be selected in accordance with present principles is shown. It is to be understood that creating and/or modifying a who icon, as well as any of the other icons as described herein, may be done in accordance with the logic set forth herein. For example, creating a who icon as will be immediately described may form part of the logic performed at block 84 of FIG. 2.

Accordingly, FIG. 7 shows a CE device 166. In the exemplary embodiment shown, the CE device 166 is a smartphone. CE device 166 presents a UI 168 which may be manipulated by a user to create/select/modify a who icon. Thus, a username entry box 170 may be presented on the UI 168 to allow the user to enter a desired username or screen name to accompany and/or be overlaid on the who icon. The UI 168 also includes a select photo selector 172 that may cause, e.g., another UI or a pop-up box to be presented on the device 166 from which a photo/image 174 may be selected.

A submit selector 176 is also shown on the UI 168 so that, once a photo/image has been selected and the UI 168 is again presented on the device 166, the username and photo may be combined by the processor of the device 166 as illustrated by the cloud 178 to generate a who icon 180 as shown. Note that a “treatment” element 182 is also shown, denoting that certain image effects that may have been specified by a user may also be used to produce the icon 180. For instance, a fade effect or other photo shop-type manipulations may be specified by the user. Last, a username element 184 is shown and illustrates that the username entered at box 170 is also combined to produce the icon 180. Note that although the who icon creation presently described (or any other icon selection/creation/modification described herein) is disclosed as being created/modified/selected at the CE device 166 which may then sent to a server to be forwarded to a recipient, all or part of the logic to create such an icon may be executed by a server as well, including a Me Too server hosting a Me Too platform/service.

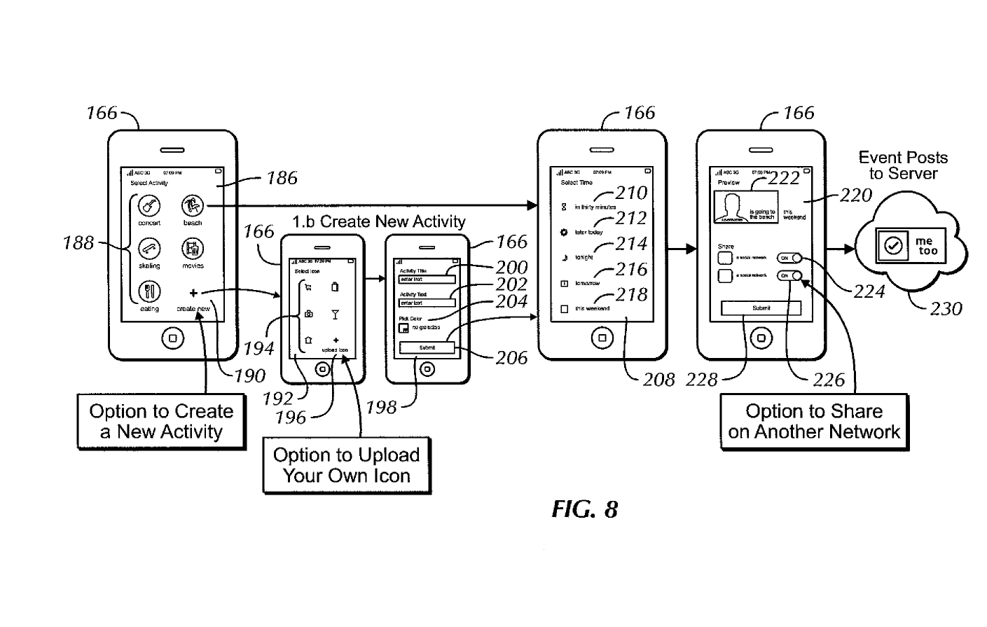

Moving on, reference is now made to FIG. 8. FIG. 8 again shows the device 166, this time with a what UI 186 presented thereon. The UI 186 facilitates creation of a what icon in accordance with present principles, and may be presented on the device 166 after the who icon has been created as described above. Thus, the UI 186 includes plural activity icons 188 that includes an image and optionally also includes alpha-numeric language corresponding to the image. The UI 186 also includes a “create new” selector 190 that, when selected, causes the UI 192 to be presented on the device 166 as shown.

The UI 192 includes plural images 194 that are selectable and/or combinable with each other to form part of the what icon to be created. UI 192 also shows an upload icon selector 196 which may be selected after at least one of the images 194 has been selected to cause the at least one image to be used by the processor of the device 166 to create the icon. Thereafter, a UI 198 also shown in FIG. 8 may subsequently be presented on the device 166. The UI 198 includes an activity title box 200 where a user may input a desired title to correspond to the image for an activity selected from the UI 192. An activity text box 202 is also shown, which allows a user to input additional text regarding the activity to be included with the what icon being created. If desired, the UI 198 may also include an icon presentation parameter selector 204 that allows a user to select certain presentation parameters for the icon, e.g., by causing another UI not shown to be presented on the device 166. The parameters may include things such as color, fade, 3D, etc. Note that the UI 198 also shows a submit selector 206 to submit the user's selections to the processor of the device 166 in accordance with present principles to thereby create the what icon.

Still in reference to FIG. 8, responsive to the submit selector 206 being selected to thus cause a new what icon to be created, or responsive to one of the what icons being selected from the UI 186, a UI 208 may be presented on the device 166. The UI 208 prompts a user to select a time for when the user intends to participate in the activity or event reflected by the what icon previously selected. Note that as shown, the UI 208 does not include a precise time of day such as, e.g., 10:19 am. Instead, the UI 208 includes selectors for more general times of day and/or future days, although it is to be understood that precise times of day may also be presented on the UI 208, either exclusively or in combination with more general times. Accordingly, the UI 208 includes an “in thirty minutes” selector 210, a “later today” selector 212, a “tonight” selector 214, a “tomorrow” selector 216, and a “this weekend” selector 218. It is to be understood that still other times may be included, such as, e.g., “next week,” “next weekend,” “next month,” “in two months,” “next year,” etc.

Even further, present principles recognize that the Me Too app may be used to display past events to friends of a user should the user simply wish to inform his or her friends/family of what the user has done in the past. So, for instance, the user of the device 166 may create a Me Too entry for a concert that the user recently attended, and hence the UI 208 may in some embodiments include a general past times to be used with a concert what icon. For example, a “yesterday” or “last week” selector may be presented on the UI 208 either in combination with the future general times, or in a separate UI and/or logic flow/process specifically for creating past events. Moreover, once such a past event has been created, a Me Too icon may be presented on the friends' devices using their Me Too apps such that, e.g., a friend of the user of the device 166 may select the Me Too icon to show their community of friends that they both attended a concert yesterday.

Continuing the description of FIG. 8, after one of the selectors 210-218 is selected, either a “submit” selector (not shown) may be selected to cause the UI 220 to be presented, or the UI 220 may be presented automatically responsive to one of the selectors 210-218 being selected. Either way, FIG. 8 shows that the device 166 then presents the UI 220, which is a preview of the Me Too event and/or icon being created and about to be published/distributed/posted to the user's friends and family. Note that at the top of the UI 220, the who icon, what icon, and when icon have been combined to create a unified banner-like icon 222, although it is to be understood that they may also be presented such that they are spaced apart from each other. Also note that the UI 220 lists other social networks and/or applications on which the Me Too application is configured to publish/post the activity through, e.g., linking the user's Me Too account with the user's Facebook and Twitter accounts. Thus, selector 224 may be selected to turn Facebook sharing of the activity on or off, and likewise selector 226 may be selected to turn Twitter sharing of the activity on or off.

Note that when the activity is published, shared, etc. on Facebook and/or Twitter, the icon 222 may be shown on those services just as it appears on the UI 220. However, the content and/or data reflected in the icon 222 may also be published in other ways on other social networking services, such as, e.g., in plain text. Manipulating the data represented on the icon 222 to present it in another form may be done by the Me Too app prior to sending the data to the other service, and/or may be done by the service itself upon receiving the icon 222.

Still in reference to the UI 220, note that it also includes a submit button 228 which, when selected, publishes and/or otherwise transmits the icon/message 222 to contacts of the user, where those contacts may be selected and/or predetermined as set forth above. Should either of the selectors 224 or 226 be set to the on position, selection of the submit button 228 also causes the icon 222 and/or data reflected by the icon 222 to be published on those services as well. As FIG. 8 shows, the device 166 may transmit such icons/information/messages by sending it to a server represented by cloud 230 in FIG. 8 that may be, e.g., a designated Me Too server for supporting a Me Too social networking service accessible over a wide area network such as the Internet. However, it is to be understood that any of the messages disclosed herein may also be transmitted from one device to another over, e.g., a wireless telephone network without having the message be transmitted through, e.g., an Internet server.

Note that in addition to the foregoing, the UIs described in reference to FIGS. 7 and 8 may also include, e.g., a question mark selector which may be selected to change a title or caption associated with an icon. Thus, for instance, a user may wish to use a certain image presented on the 186 when creating/using a what icon, but wish to change only the caption included therewith.

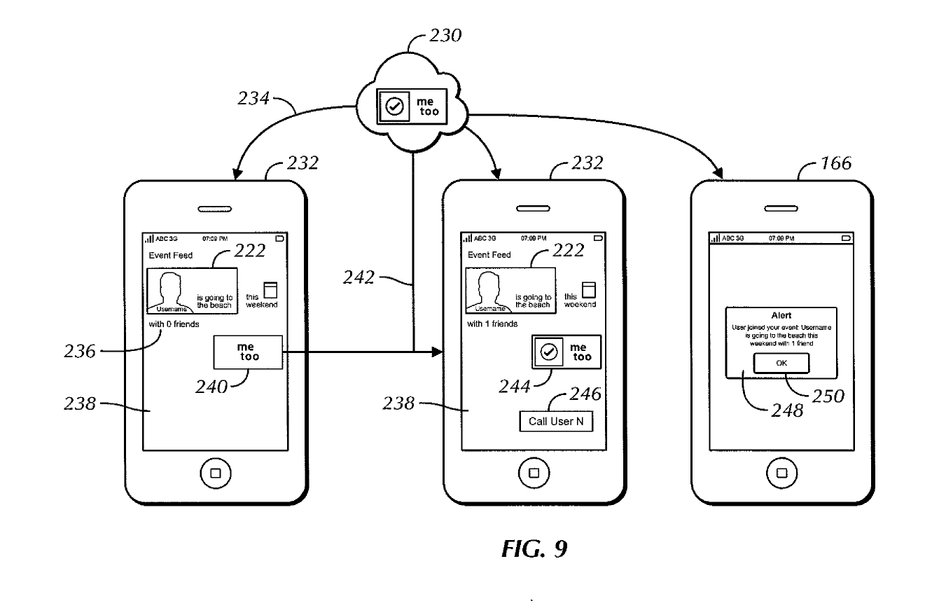

Reference is now made to FIG. 9, which shows the Me Too message/icon 222 being transmitted at least to another CE device 232 (e.g., of the user's friend) from the Me Too server 230 after the server 230 has received it from the device 166. It is to be understood, however, that the message may be pushed to any and/or all devices associated with people connected to the creator of the activity, e.g., through a Me Too social networking service as described herein. Thus, anyone who is connected to the creator of the activity can view the posting (e.g., the icon 222) on their device and/or be notified accordingly.

As indicated by arrow 234, the message/icon 222 is transmitted to the device 232, which presents it on a UI 238. It may be presented automatically without user interaction upon receipt at the device 232, and/or a notification may be presented on the device 232 notifying the user of the device 232 that a Me Too message is waiting to be viewed. Note that an indication 236 notifies the user of the device 232 that no one other than the creator of the activity has indicated they will join in the activity with the creator. The UI 238 also includes a Me Too icon in accordance with present principles that is selectable to cause the device 232 to transmit an accept and/or join message back to the server 230 so that the server 230 may then forward the accept/join message back to the device 166 indicating that a contact to which the icon 222 was sent will join in the activity, as indicated by arrow 242. As also shown in FIG. 9, the icon 240 changes to include a check mark 244 reflecting that the user of the device 232 will be joining in the activity. The indication 236 also changes to reflect that at least one friend—in this case, the user of the device 232—will be joining in the event. Note that although the present figure is being described as though the UI 238 changes to reflect information responsive to the icon 240 being selected, note that a separate UI may instead be presented similarly reflecting what is described above in other embodiments. Regardless, note that a selector 246 is also presented responsive to the Me Too icon 240 being selected. The selector 246 may be selected to cause the device 232 to call the device 166 associated with the creator of the activity so that, e.g., the two users can better coordinate their meet up for the activity (e.g., to meet at a particular part of a park or structure). Accordingly, in some embodiments the message/icon 222 may include the sender's telephone number to facilitate the call responsive to selecting the selector 246.

Continuing in reference to FIG. 9, note that the server 230 may forward a new message and/or the accept message described above to the device 166 responsive to the Me Too icon 240 being selected to thereby notify a user of the device 166 that the friend is joining in the activity. Thus, as shown the device 166 may present a pop-up alert 248 indicating that one friend will be participating in the activity with the user of the device 166. An “ok” selector 250 is also shown, which when selected causes the alert 248 to cease being presented on the device 166.

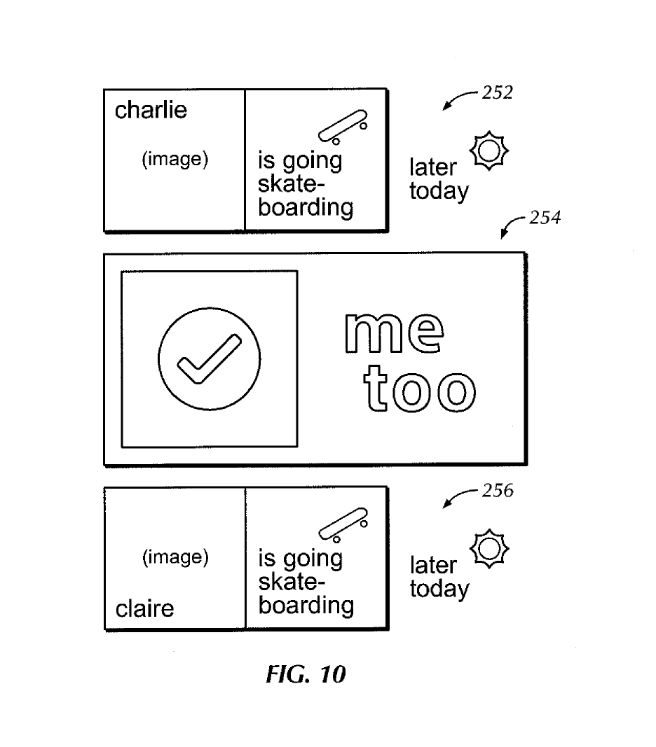

Moving on to FIG. 10, exemplary icons to be used in accordance with present principles are shown. Thus, an icon 252 indicates that a Me Too user named Charlie is going skateboarding later today. A Me Too icon 254 may be selected by another Me Too user such as Claire. Responsive to the Me Too icon 254 being selected by Claire when viewing Charlie's activity, an icon 256 for Claire may also be created and, e.g., pushed to Claire's friends and/or published/posted on a social network indicating that Claire is also going skateboarding later today. In some embodiments, the creation of the icon 256 may be done automatically without further user action by Claire responsive to her selecting the icon 254 on her CE device.

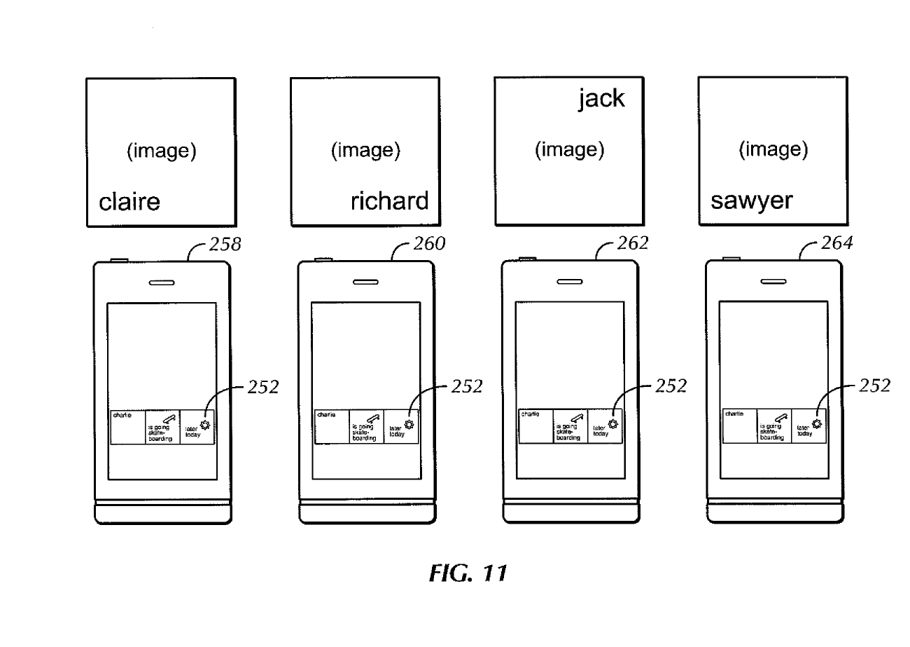

FIG. 11 illustrates that the icon 252 may be pushed to plural CE devices once created by Charlie, where each CE device is associated with a different contact of Charlie's. Thus, Claire's CE device 258 receives the message/icon 252 and presents it thereon, as does Richard's CE device 260, Jack's CE device 262, and Sawyer's CE device 264. Assuming that all four of Claire, Richard, Jack, and Sawyer wish to join in Charlie's Activity, the icon 252 as presented on Charlie's CE device (or alternatively a new icon similarly reflecting the information of the icon 252) now indicates that four friends will be joining in the event. If desired, the portion of the icon 252 indicating that four friends are joining may be selectable to cause Charlie's CE device to show the specific contacts that are participating (e.g., by showing who icons associated with Claire, Richard, Jack, and Sawyer).

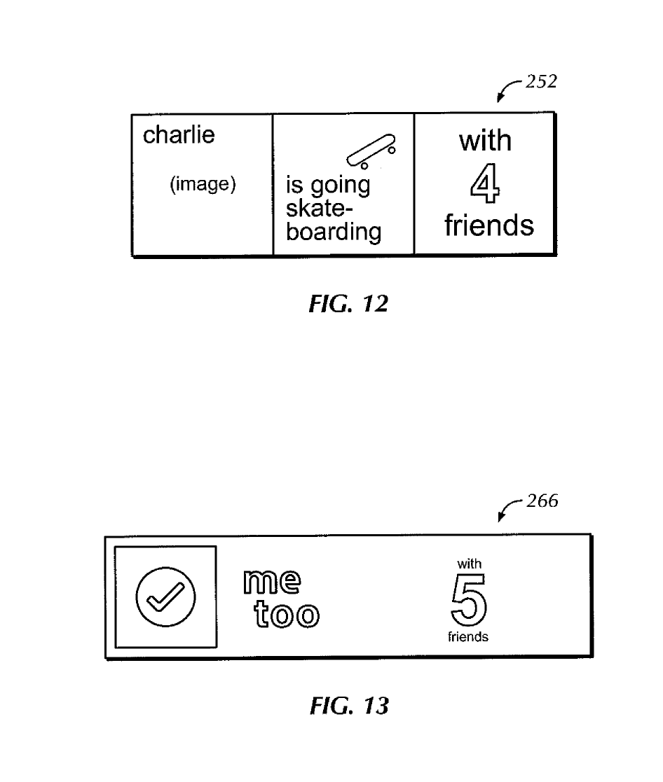

Rather than changing the icon 252 as shown in FIG. 12 to reflect that four friends will be joining Charlie, a new icon/message 266 as shown in FIG. 13 may be created and presented in accordance with present principles (e.g., by the server 230 once receiving Me Too icon selections from Claire et al.) for presentation on Charlie's CE device. Thus, as may be appreciated from FIG. 13, the icon 266 includes the wording “me too” with a check mark that resembles the Me Too icons described above, as well as an indication that five friends will be joining Charlie in his activity.

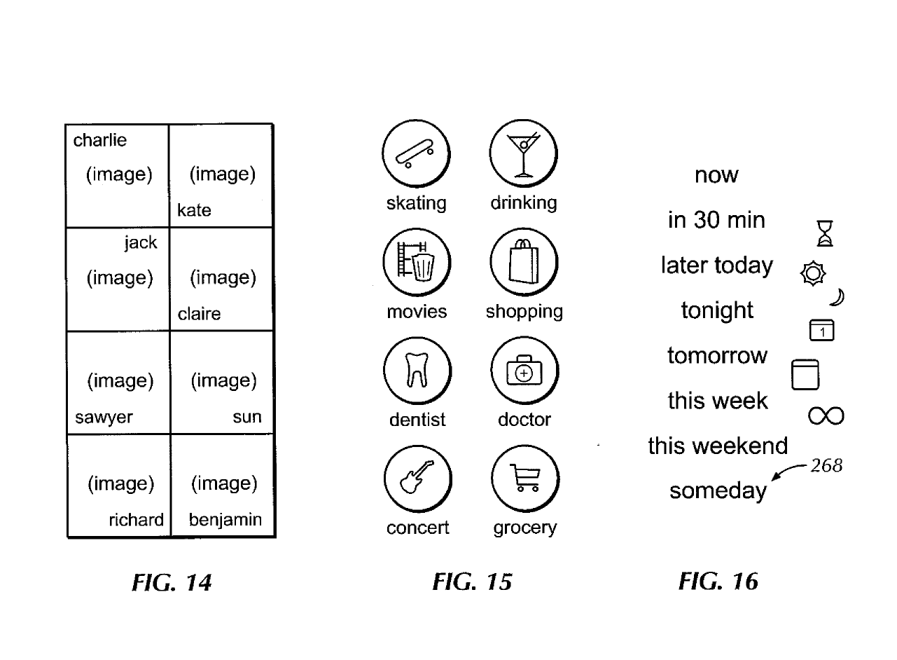

Continuing the detailed description in reference to FIGS. 14-16, exemplary who icons are shown in FIG. 14, exemplary what icons are shown in FIG. 15, and exemplary when icons are shown in FIG. 16. It is to be understood that all of the icons shown in FIGS. 14-16 are selectable in accordance with present principles. Note that other what icons besides those shown in FIG. 15 may be used in accordance with present principles, such as, e.g., activity icons for a wedding, a birthday, graduation, holidays, etc. Note that FIG. 16 shows a “someday” what icon 268 that may be selected to indicate a Me Too user wishes to participate in an activity at an unspecified, possibly unknown, future time.

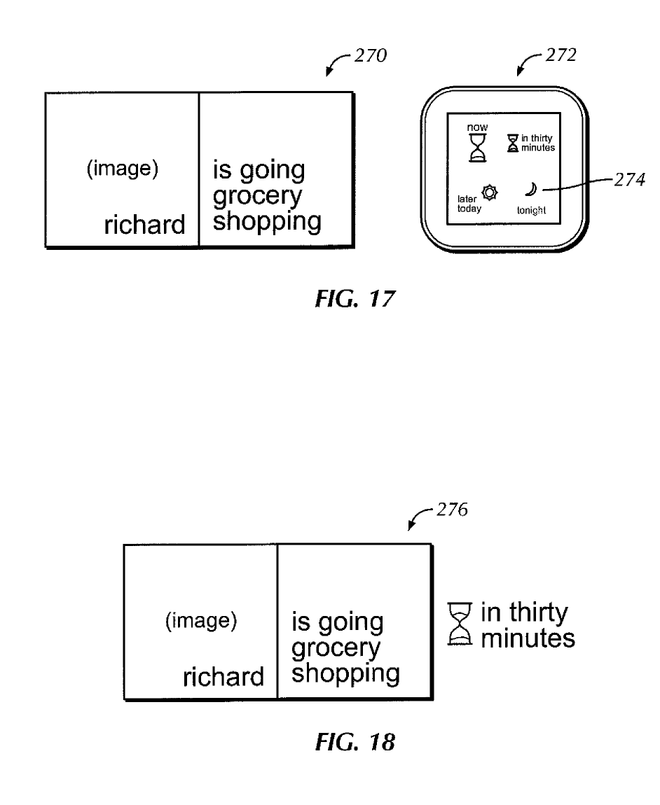

Turning now to FIG. 17, an exemplary Me Too message/icon 270 is shown. It indicates that a user, Richard, is going grocery shopping. FIG. 17 also shows a smart watch 272 manufactured by Sony Corporation that is manipulable by Richard to create the message/icon 270. Note that as shown, the message/icon 270 thus far only includes a who icon and a what icon, and that the smart watch 272 is presenting a UI 274 for Richard to select a when icon to be included in a completed Me Too activity message/icon. FIG. 18 thus shows a completed icon 276 for Richard's activity that may be created once Richard selected a when icon from the UI 274.

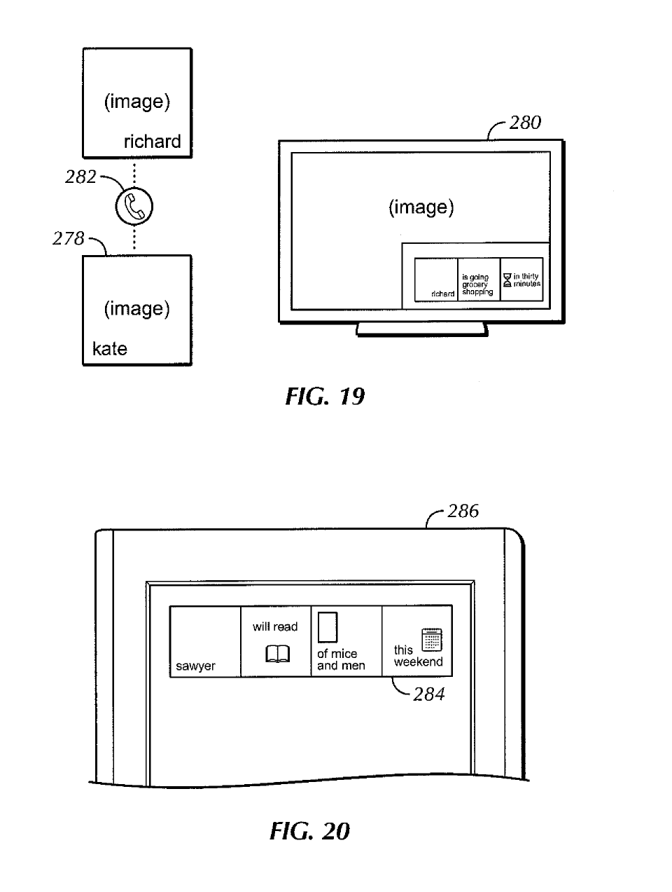

As may be appreciated from FIG. 19, the icon 276 may then be transmitted to, e.g., a user named Kate associated with a who icon 278. Kate's smart TV 280 may thus present the icon 276. As shown in FIG. 19, upon viewing the icon 278 on the TV 280, Kate calls Richard as indicated by the telephone icon 282 to, e.g., request that Richard pick up something for her while at the grocery store (which is the activity in which Richard will be participating).

Now in reference to FIG. 20, yet another exemplary Me Too activity icon/message is shown. A Me Too activity icon 284 is thus presented on a tablet computer 286. The icon 284 indicates that a user named Sawyer will read the book Of Mice and Men this weekend.

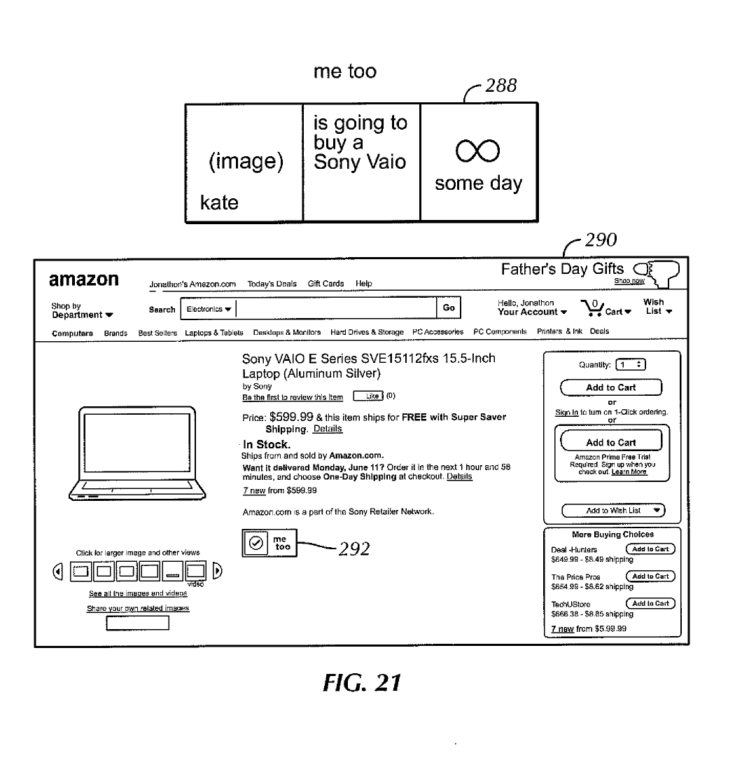

Yet another exemplary Me Too activity icon/message is shown in FIG. 21. FIG. 21 shows an activity icon 288 indicating that a user named Kate wishes to buy a Sony Vaio computer “some day” in the future. FIG. 21 also shows an Amazon.com webpage 290 showing the Sony Vaio computer for sale that Kate wants. It is to thus be understood that should Kate's activity icon 288 be selected by one of her contacts on that contact's CE device, the CE device of that contact may cause the web page 290 to be presented so that the contact can view the computer Kate wants. Note that a Me Too icon 292 is also shown on the web page 290. The icon 292 may be selected by Kate to initiate a process to create the icon 288, and, e.g., when viewed on the CE device of Kate's contact can be selected by the contact to cause an icon to be created to reflect that the contact also wants the same product.

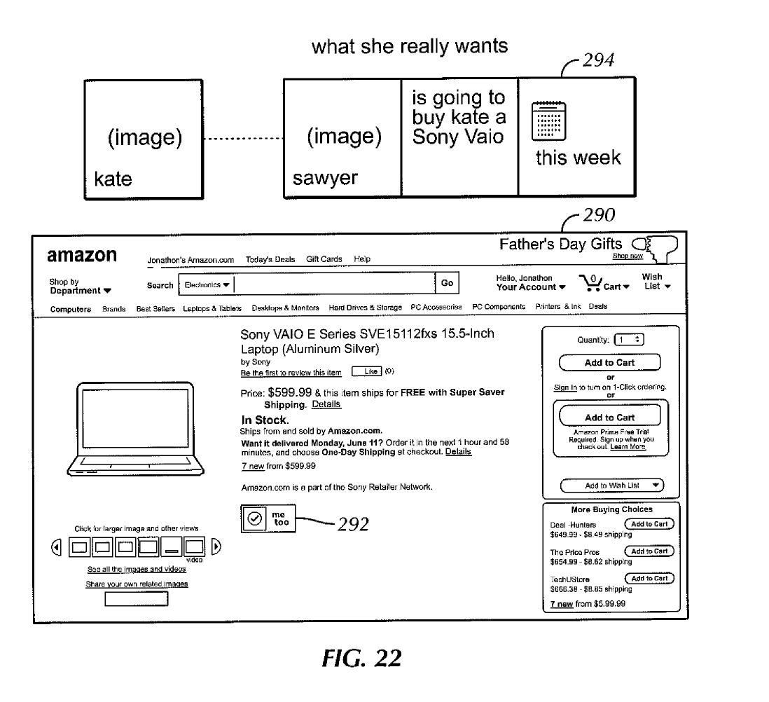

Furthermore, as appreciated from FIG. 22, Kate's contact Sawyer may view the web page 290 and decide he wishes to buy Kate the computer she wants. Thus, Sawyer may select the Me Too icon 292 as presented on his device to create an activity icon 294 indicating that Sawyer will be participating in the activity of buying Kate a Sony Vaio computer this week.

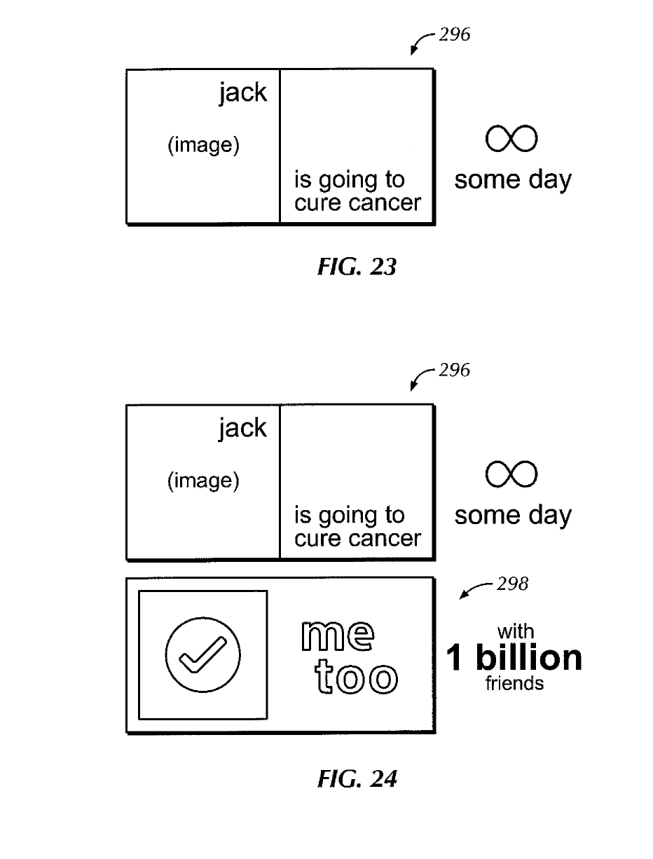

As but one last example, FIG. 23 shows another exemplary activity icon. The icon 296 indicates that Me Too user Jack will be curing cancer some day. Then, as shown in FIG. 24, Jack's activity is joined by one billion users as reflected by icon 298.

Concluding the detailed description, it is to be understood that all of the icons described herein are exemplary and that they may be combined in other ways and/or show combinations of who, what, and when icons that do not necessarily include all three in a finished activity icon. Thus, e.g., activity icons may be created that combine only who and what icons. It is to also be understood that all of the UIs described above are exemplary and may include, e.g., more or less information and selectors than what is described above in certain embodiments.

Further, it is to be understood that the messages and/or icons disclosed herein may be transmitted automatically such that they do not require additional user action/input once the selectors described above are selected. For example, after a selection of a when icon at block 94 of FIG. 2, an activity icon may be created by the processor and automatically transmitted to one or more contacts. In addition, it is to also be understood that in response to receiving an activity icon/message, e.g., a text message, email, etc., response may be transmitted back to the sender rather than a Me Too accept message if desired, and the text message or email may even be created by a recipient using audible commands input to the recipient's CE device.

Even further, note that cloud computing/technology may also be used in accordance with present principles.

In addition to all of the foregoing, note that the devices described above may be GPS enabled and that the icons and UIs described above may include GPS selectors as well that, when selected, cause the device to present directions to the activity in which the user of the device will participate. Thus, in some embodiments, the creator of the activity may input specific location information to his or her device when creating a Me Too activity icon so that others may obtain directions when joining in the activity by selecting, e.g., a Me Too icon such as those described above from their respective devices.

Moreover, still other activities besides those described above may be participated in. For instance, an activity icon can be created for, e.g., car shopping. As another example, a Me Too application can be used to share a gift registry E-store with friends so that friends may purchase gifts for a wedding. Furthermore, selection of a purchase activity icon by a recipient (e.g., such as for the computer described above) may cause another function/application to be launched on the recipient's CE device, such as to search for the best price for the item to be purchased (e.g., Sawyer may be able to locate an E-store selling the computer Kate wants for less than Amazon.com). Even further, when purchasing an item for a Me Too contact in accordance with present principles, other embodiments may include, e.g., responsive to selection of a Me Too icon on a webpage, a third party server presenting a UI or some other type of interface/input screen to the purchaser requesting the purchaser input information such as who the purchaser will be sending the item to. The what icon for the item could even be auto-filled on such an interface, as could a certain time when the purchase will be made and/or the item will be delivered. This information could also be published on a Me Too platform/service or another social networking services in accordance with present principles.

Additionally, the who, what, and when icons described herein may be created by users of a Me Too application, but note that some icons (e.g., default icons) may be included in the Me Too application when, e.g., initially installed on a CE device. Images for the icons described above may also be chosen from, e.g., websites and need not necessarily be photographs of respective Me Too users. Character recognition may also be used, e.g., in conjunction with voice commands to select images for the icons from web pages. Also note that emoticons may also be included in any of the messages and/or icons described above to reflect a user's state of mind.

Last, note that other ways of creating icons such as a what or who icon may be used in accordance with present principles. For example, an image stored on a CE device may be used for a what icon, and/or a table of images and words that may be associated with them may be presented for a user to select a particular image to include particular descriptive words overlaid on it.

It may now be appreciated that a user may quickly and easily share an event in which they are going to participate with friends and family. This may be done on relatively small devices such as, e.g., smart phones or smart watches that would otherwise make it difficult to share such information because of their small screen size and hence limited ability to type and display textual information pertaining to an activity. In this sense, the activity icons described above provide a story board of information that can be exchanged over social media.

While the particular SYSTEM AND METHOD FOR SHARING EVENT INFORMATION USING ICONS is herein shown and described in detail, it is to be understood that the subject matter which is encompassed by the present invention is limited only by the claims.

What is claimed is:

1. An apparatus comprising:
at least one processor;
at least one display controlled by the processor; and
at least one wireless transceiver communicating with the processor, the processor configured to send, to at least one recipient, a message including data representing at least one non-alphanumeric who icon representing a person, at least one non-alphanumeric what icon representing an event and/or activity, and at least one non-alphanumeric when icon representing a time associated with the event and/or activity.

2. The apparatus of claim 1, wherein the message further includes data representing an alpha-numeric descriptor of at least one icon for overlay of the descriptor on the at least one icon at a recipient device.

3. The apparatus of claim 1, wherein the message does not include data representing any alpha-numeric descriptor of the icons.

4. The apparatus of claim 1, wherein the processor is also configured to automatically add the event and/or activity to a calendar to reflect that the person is participating in the event and/or activity represented by the what icon at the time represented by the when icon.

5. The apparatus of claim 1, wherein the processor is configured to send the message to plural recipients on a predefined contact list.

6. The apparatus of claim 1, wherein the message includes a selectable invitation for the recipient to join, the message configured to cause, when the invitation is selected, the recipient to send an accept message back to the apparatus.

7. The apparatus of claim 1, wherein the processor is also configured to cause an event page reflecting information about the event and/or activity to be created on a social networking service.

8. The apparatus of claim 1, wherein the apparatus is a telephone and the message includes a call selector element configured to cause, when selected the recipient, the recipient to call the apparatus.

9. The apparatus of claim 1, wherein at least one of the icons was created in response to at least one voice command to create the icon.

10. The apparatus of claim 10, wherein at least one of the icons created in response to the voice command reflects information provided in the voice command.

11. An apparatus comprising:
at least one processor;
at least one display controlled by the processor; and
at least one wireless transceiver communicating with the processor and configured to receive, from at least one sender, a first message including data representing at least one non-alphanumeric who icon representing a person, at least one non-alphanumeric what icon representing an event, and at least one non-alphanumeric when icon representing a time associated with the event, the processor configured to cause the icons to be presented on the display along with a me too icon selectable to cause the processor to return a second message to the sender indicating a desire to join the event.

12. The apparatus of claim 11, wherein the first message further includes data representing an alpha-numeric descriptor of at least one of the icons for overlay of the descriptor on the at least one icon.

13. The apparatus of claim 11, wherein the first message does not include data representing an alpha-numeric descriptor of the icons.

14. The apparatus of claim 11, wherein the processor is also configured to cause a calendar associated with the apparatus to reflect that the recipient is participating in the event represented by the what icon at the time represented by the when icon.

15. The apparatus of claim 11, wherein the second message is also sent to at least one other person on a predefined contact list.

16. The apparatus of claim 11, wherein the me too icon is selectable using a voice command.

17. A method, comprising:
presenting at least one selectable element on a sender consumer electronics (CE) device;
responsive to user selection of the at least one element, creating a first message including data representing at least one non-alphanumeric what icon, the what icon representing an item, a location, an event, and/or activity; and
transmitting the first message to at least one recipient CE device for presentation on the recipient CE device;
wherein the message includes a selector configured to cause, when selected by the recipient at the recipient CE device, a second message to be automatically sent from the recipient CE device to the sender CE device indicating the user of the recipient CE device also wants the item, intends to meet at the location, and/or intends participate in the event and/or activity.

18. The method of claim 17, wherein the second message includes an emoticon.

19. The method of claim 17, wherein the message is further configured to cause, responsive to selection of the selector, the recipient CE device to automatically add the item, location, event, and/or activity to an application associated with the user of the recipient CE device.

20. The method of claim 17, further comprising, after creating the first message, creating an event page on a social networking service containing information about the item, location, event and/or activity.
